(19) United States
(12) Patent Application Publication
(10) Pub. No.: US 2026/0315314 A1
(43) Pub. Date: Oct. 15, 2026

(54) APPARATUS FOR THE PREVENTION OF TUMOR RECURRENCE

(71) Applicants: UNIVERSITÀ DEGLI STUDI DI SIENA, Siena (SI) (IT); CENTRO CARDIOLOGICO MONZINO S.P.A., Milano (MI) (IT); INTERNATIONAL CENTRE FOR GENETIC ENGINEERING AND BIOTECHNOLOGY - ICGEB, Trieste (TS) (IT)

(72) Inventors: Domenico PRATTICHIZZO, Siena (SI) (IT); Serena ZACCHIGNA, Trieste (TS) (IT); Alberto VILLANI, Siena (SI) (IT)

(73) Assignees: UNIVERSITÀ DEGLI STUDI DI SIENA, Siena (SI) (IT); CENTRO CARDIOLOGICO MONZINO S.P.A., Milano (MI) (IT); INTERNATIONAL CENTRE FOR GENETIC ENGINEERING AND BIOTECHNOLOGY - ICGEB, Trieste (TS) (IT)

(21) Appl. No.: 19/485,878

(22) PCT Filed: May 23, 2024
(86) PCT No.: PCT/IB2024/055010

§ 371 Date: Nov. 19, 2025

(30) Foreign Application Priority Data
May 25, 2023 (IT) 102023000010590

(51) Int. Cl. A61H 23/00; A61H 23/04

(52) U.S. Cl. CPC A61H 23/006; A61H 23/04; A61H 2201/1238; A61H 2201/165; A61H 2201/5061; A61H 2201/5071; A61H 2201/5082

(57) ABSTRACT

A wearable apparatus for treating of cancer cells through mechanical stimulation of a patient's skin, subcutis or mammary gland is provided. The apparatus includes a support element applied on the patient's tissue and a stimulation and control device connected to the support element. The stimulation and control device includes an actuator for transferring the mechanical stimulation at a stimulation point, a sensor for detecting a physical property at the tissue of the patient and for generating a corresponding sensor signal, and a control unit connected to the actuator and to the sensor for regulating the activity of the actuator with a control signal as a function of the sensor signal. The mechanical stimulation is transferred from the actuator to the stimulation point and causes a deformation of the tissue to be treated, by contraction and release of the tissue, via a cyclical trend.

### TECHNICAL FIELD

The present invention relates to a wearable apparatus for the treatment of cancer cells through a mechanical stimulation of a patient's surface tissue, in particular the skin, the subcutis or the mammary gland.

### STATE OF THE ART

Cancer is the second leading cause of death globally, placing a huge physical, emotional and financial burden on patients, their families, the community and health systems. To date, the control and prevention of local cancer recurrence is one of the greatest needs not yet fully met. The occurrence of a recurrence usually precedes metastatic dissemination and has a negative impact on both long-term survival and the quality of life of patients. The therapies currently used for the treatment cancer and the prevention of recurrence have significant side effects and are mainly based on the systemic treatment of metastatic disease, a point in which a long-term cure is rarely possible. For decades, the main effective treatment for cancer has been chemotherapy. The success of this therapy is still limited by off-target toxicity and the selection of drug-resistant cancer cells. More recently, immunotherapy and targeted therapies have attracted attention because of their greater specificity towards cancer cells. These approaches show promising results in clinical trials for multiple types of cancer, either used alone or in conjunction with traditional drugs. However, not all patients respond positively to these therapies and are often burdened with significant toxicity, in particular to the cardiovascular system. Therefore, local recurrence is still a medical need. No solutions are currently available to control the recurrence and spread of cancer locally.

Encouraged by some evidence on tumour non-proliferation in the human and mouse heart, medical-biological investigation has oriented the search for the inhibitory causes of the tumour towards biological-mechanical interaction phenomena.

The progression of cancer is known to be influenced by mechanical stimuli. Changes in tissue stiffness and density are important stimuli of tumour progression and are often exploited in cancer diagnosis by both palpation and imaging. However, if the biological-mechanic interaction has revealed how mechanical properties (stiffness, elasticity) affect the growth of cancer cells, little is still known about the actual role of mechanical stimuli (pressure, tension).

The mammalian heart is rarely affected by cancer, perhaps due to the same mechanisms which stop cardiac regeneration. Primary myocardial tumours are extremely rare, with a prevalence of approximately 0.0017%. Heart metastases often affect the pericardium or large vessels, and not the myocardium. Furthermore, cancer cells implanted ectopically in the heart form small tumours, which are not vascularized, indicating that the cardiac environment hinders the growth of both endothelial and cancer cells. At the same time, it is known that the mammalian heart loses its regenerative capacity quite quickly after birth. In particular, it is possible to determine the mechanisms that stop the proliferative potential of cardiac cells, both cardiomyocytes (CMS) and cardiac endothelial cells, after birth. Among these, mechanical stimuli are emerging as key players. In particular the mechanical discharge of the heart, as occurs in patients implanted with a Left Ventricular Assisted Device (LVAD).

Devices and procedures for the treatment of cancer cells by mechanical stimuli are known in the literature. For example, EP 3 312 506 A1 discloses a device for the treatment of tumours in the gastrointestinal tract through a mechanical stimulation of tissues and WO 2020/223242 A1 discloses a method for treating cancer cells through external mechanical stimulation (pneumatic or hydraulic) at a specific frequency and intensity such as to induce cell death (apoptosis). However, in many cases these solutions involve treatments inside the human body and therefore require surgical intervention on the patient. Furthermore, even in the case of external treatments, bulky, expensive equipment is often necessary and can only be used by specialized personnel. In this case, the patient is obliged to go to special hospital facilities to receive the treatment.

Therefore, an object of the present invention is to provide an apparatus for the treatment of cancer cells which partially or completely overcomes the drawbacks of the prior art. In particular, it is an object of the present invention to obtain an apparatus which is effective, easy to use and which does not oblige the patient to stay inside medical facilities during the treatment.

### DISCLOSURE OF THE INVENTION

These objects are achieved by a wearable apparatus according to the claims at the end of the present disclosure.

In an aspect of the invention, a wearable apparatus is provided for the treatment of cancer cells through a mechanical stimulation of a patient's surface tissue, in particular the skin, the subcutis or the mammary gland. The apparatus comprises a support element applicable on the tissue of said patient and a stimulation and control device connected to the support element, in which said stimulation and control device comprises:
at least one actuator for transferring the mechanical stimulation at at least one stimulation point;
at least one sensor for detecting a physical property at the tissue of the patient to be treated and for generating a corresponding sensor signal; and
a control unit connected to the actuator and to the sensor for regulating the activity of said actuator by means of a control signal as a function of at least said sensor signal, wherein the mechanical stimulation is transferred from the actuator to the stimulation point so as to determine a deformation of the tissue to be treated, in particular a contraction and a release of said tissue, according to a cyclical trend.

It should be noted that the deformation of the stimulation points, and thus of the tissue to be treated, can be comparable to a cyclical function which alternates a compression and a release of the treated tissue. Thereby, the tissue represents a dynamic environment highly unfavourable to tumour proliferation by mechanically-activated biological mechanisms.

For example, the cyclical trend can be comparable to a cardiac cycle, i.e., the forces and deformations of the mechanical stimulation by the device can be comparable to the forces and deformations to which the heart is subjected. However, other cyclical trends, different from the cardiac one, can be advantageously used to achieve the same purpose.

Furthermore, it should be noted that the tissue to be treated is mechanically stimulated and not through an electric discharge as occurs, for example, with the muscle stimulators known in the literature.

These and other aspects of the present invention will become more apparent by reading the following description of some preferred embodiments disclosed below.

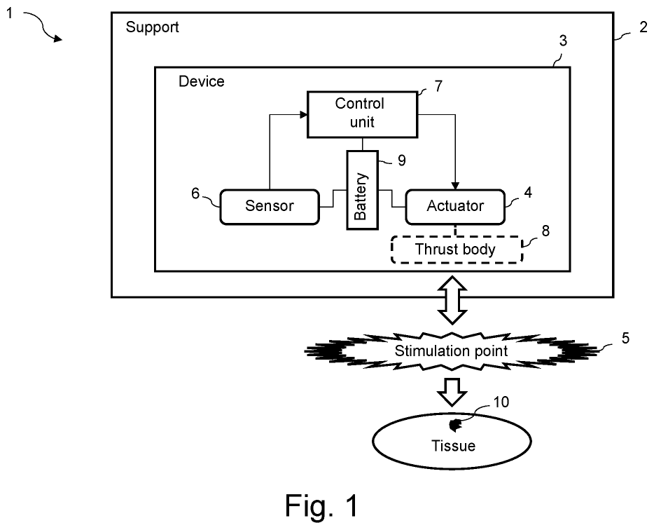

FIG. 1 shows a schematic representation of an apparatus for the treatment of cancer cells according to an example.

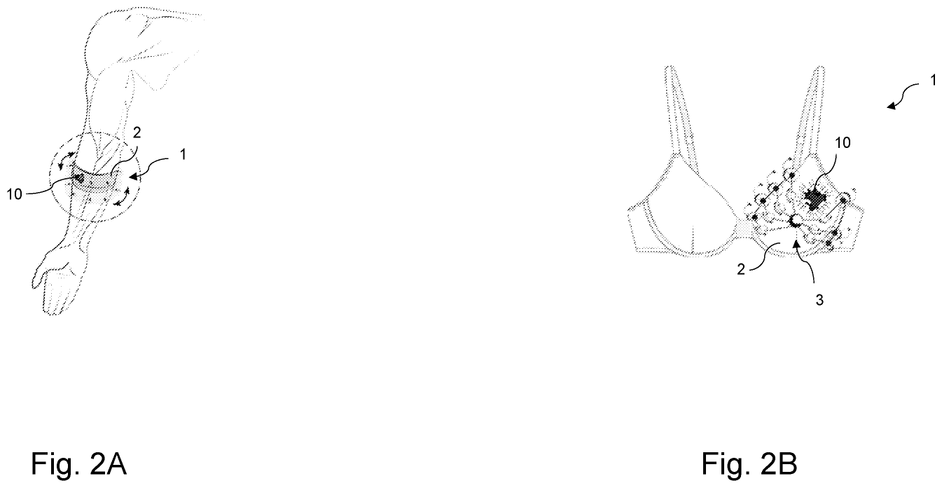

FIG. 2A-B show two possible embodiments of the apparatus in which the support element is a band (A) or an item of clothing (B).

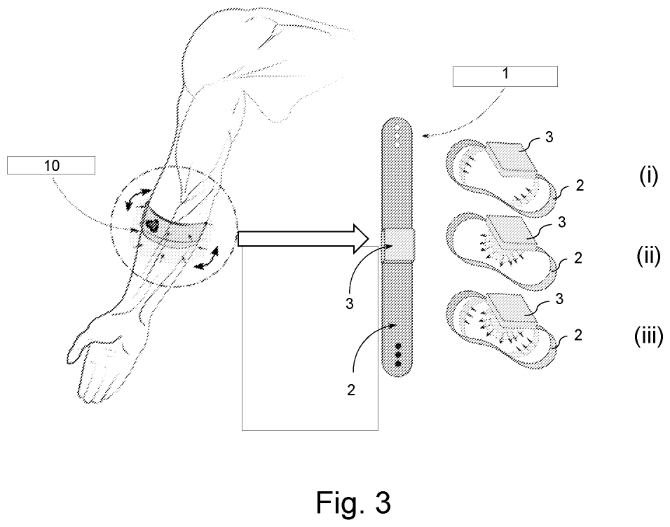

FIG. 3 schematically shows the types of stimulation of the apparatus according to the example of FIG. 2A.

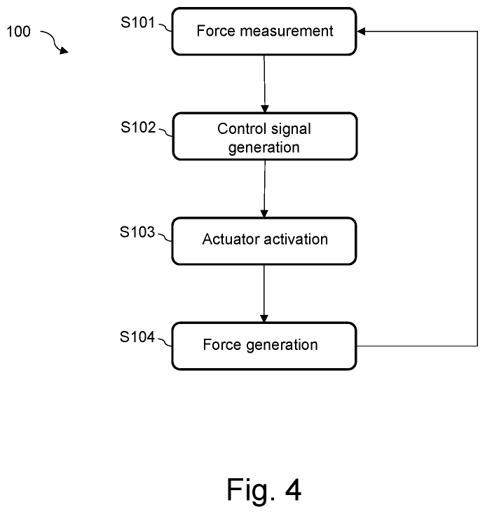

FIG. 4 shows a flow diagram of the closed-loop control according to an example.

FIG. 1 shows an apparatus 1 for the treatment of cancer cells 10 through a mechanical stimulation. In particular, the apparatus 1 is capable of reproducing—or simulating—mechanical stimuli locally, such as those which characterize a cardiac cycle, on a skin or sub-cutaneous tissue for the prevention of tumour recurrence which are reachable by tactile stimulation, such as melanomas, breast tumours, etc.

Advantageously, the apparatus 1 is wearable and comprises a support element 2 which can be applied to the patient's tissue. For example, the support element 2 can be made of textile material in the form of a band or an item of clothing (bra, tank top, t-shirt, stocking, etc.). The support element 2 can of course be made of various materials, such as for example natural fibre or synthetic fibre materials. Furthermore, the support element 2 can be made of elasticised material to facilitate contact with the skin tissue of the patient. The support element 2 can also be totally or partially made of plastic or silicone.

In order to produce the mechanical stimulation and to regulate the pulses on the patient's tissue, the apparatus 1 further comprises a stimulation and control device 3. This device 3 is connected to the support element 2 so that the stimulation generated by the device 3 can possibly be transferred to the support element 2. Advantageously, the stimulation and control device 3 can be removably connected to the support element 2. Alternatively, the stimulation and control device 3 can be integrated in the support element 2.

The stimulation and control device 3 comprises one or more sensors 6 for detecting a physical property at the patient's tissue. The sensor 6 serves to detect at least one physical property comprised between a pressure, a temperature, a hardness, a local deformation, and/or an optical property. However, other physical properties can be taken into account. For example, the sensor 6 can be a force sensor for measuring the force exerted on a region of the tissue-i.e., the pressure. The device 3 can however comprise a different sensor 6, for example a sensor for detecting the temperature or other parameters for monitoring the state of the patient's tissue and in particular of the cancer cells 10. Based on the type of sensor present, the sensor 6 generates a corresponding sensor signal comprising information related to the measured physical property. The sensor 6 can for example be a durometer for measuring the hardness of the tissue, an optical sensor for measuring the optical properties of the tissue or a strain gauge for measuring the local strain of the tissue.

In order to generate a mechanical stimulus acting on the patient's tissue, the stimulation and control device 3 further comprises one or more actuators 4. In particular, the actuator 4 serves to transfer the mechanical stimulation at at least one stimulation point 5.

The stimulation and control device 3 further comprises a control unit 7. This is connected to the sensor 6 to receive the sensor signal and is connected to the actuator 4 to regulate the activity of the actuator 4 itself by means of a control signal. The control signal is generated as a function of the sensor signal. However, the control signal can be generated as a function of other information or data defined in advance and present in the control unit 7.

The various elements of the device 1 can be powered by a battery 9. This is connected at least to the control unit 7 but can also be additionally connected to the sensor 6 and the actuator 4. Advantageously, the battery 9 is a rechargeable battery. It should be noted that the device 1 can be powered according to alternative modes which do not necessarily include a battery 9, for example by exploiting solar and/or kinetic energy generated by the patient.

It should be noted that the mechanical stimulation transferred from the actuator 4 to the stimulation point 5 causes a deformation of the tissue to be treated such as to simulate a cardiac cycle. In particular, the tissue deformation can be represented by a contraction and release of the tissue itself similar to the contraction and release of cardiac tissue during cardiac activity. In other words, the control unit 7 is programmed and thus configured so as to send a control signal to the actuator 4 and allow the actuator 4 to reproduce on the diseased tissue (at the stimulation point 5) a stimulation analogous to the heartbeat, thus emulating, locally, the force and pressure to which the walls of the heart are subjected and their deformation. The deformation of the tissue to be treated is a consequence of the movement carried out by the support element 2 at the stimulation point 5. In particular, the support element 2 is configured to expand locally at the stimulation point 5, to contract globally or due to a combination of said expansion and said contraction, according to a cyclical trend. To achieve this expansion and contraction, the support element 2 is made of deformable material. For example, the support element 2 can comprise a portion capable of varying the volume thereof. For example, by means of a pneumatic system with air passage inside a chamber, by means of a hydraulic system with liquid passage inside a chamber, by means of a piezoelectric system, by means of an external deformation element, or by means of any system capable of allowing a variation in volume of the support 2 in a cyclical manner.

As mentioned several times, the cyclic trend is similar to a typical cardiac cycle. A cardiac cycle begins with a sinusoidal rhythm, an electrical wave generated in the sinoatrial node which propagates through the conduction tissue and stimulates the contraction of the chambers of the heart, first the atria and then the ventricles, pushing the blood out of the heart.

In an example, the mechanical stimulation transferred from the actuator 4 to the stimulation point 5 causes on the tissue to be treated, i.e., on the stimulation point 5, a maximum pressure greater than 120 mmHg (i.e., about 0.16 Kgf/cm²).

To simulate the cardiac cycle, the actuator 4 transfers to the stimulation point 5 a stimulation pressure Pₛ and a relaxation pressure Pᵣ, in which the stimulation pressure Pₛ is greater than the relaxation pressure Pᵣ. In other words, in the cyclical trend according to which the support element 2 can expand and contract, the actuator 4 transfers at the stimulation point 5 a different pressure depending on whether it is in an expansion or contraction phase. The transition from one pressure value (e.g., stimulation pressure Pₛ) to another (e.g., relaxation pressure Pᵣ) can occur continuously or can follow a trend at discrete levels.

During the stimulation phase, the actuator 4 transfers to the stimulation point 5 a maximum stimulation pressure Pₛ which can assume values comprised between 125 mmHg and 250 mmHg (125 mmHg<Pₛ<250 mmHg). These values correspond to the internal pressure of the left ventricle during the systole phase and the internal pressure of the cardiac wall during the same phase, respectively. In the relaxation phase, the stimulation point 5 is subjected to a relaxation pressure Pᵣ approximately equal to 0 mmHg but always less than 7 mmHg (0 mmHg<Pᵣ<7 mmHg), which corresponds to the pressure within the left ventricle in diastole in a healthy heart.

Additionally or alternatively, the mechanical stimulation transferred from the actuator 4 to the stimulation point 5 causes on the stimulation point 5 and therefore consequently on the tissue to be treated a maximum local volumetric deformation of at least 130 ml. In this context, local volumetric deformation indicates a change in volume of the stimulated tissue site between a compression phase and a release phase.

Additionally or alternatively, the mechanical stimulation transferred from the actuator 4 to the stimulation point 5 causes on the stimulation point 5, and thus consequently on the tissue to be treated, a frequency greater than or equal to 0.05 Hz, in particular a frequency greater than or equal to 1 Hz, more in particular a frequency comprised between 1 Hz (60 beats per minute, bpm) and 2 Hz (120 bpm), emulating the heart rate of a healthy heart in conditions of rest and under stress. It should be noted that the frequency is not varied randomly but according to a certain cycle, i.e., the cardiac cycle, as mentioned above.

In other words, to simulate the cardiac cycle of a healthy human heart, the wearable apparatus 1 disclosed herein can transfer a mechanical stimulation at the stimulation point 5, and thus consequently on the tissue to be treated, having a pressure varying between a stimulation pressure Pₛ and a relaxation pressure Pᵣ, according to the parameters disclosed above. In addition to these pressure values, the wearable apparatus 1 described herein can transfer a mechanical stimulation with a frequency according to the parameters described above. By combining these frequency and pressure values it is possible to more effectively simulate the cardiac cycle.

In addition to these pressure and frequency values, the wearable apparatus 1 described herein can transfer a mechanical stimulation with a volumetric variation according to the parameters disclosed above. By combining these values of frequency, pressure and volumetric variation, it is possible to simulate the cardiac cycle even more effectively.

It should be noted that the normal duration of a cardiac cycle at rest is about 0.8 seconds. Within such a duration, one third of the time is occupied by the systolic phase, i.e., contraction of the ventricular chambers, and two thirds of the time by the diastolic phase, i.e., relaxation of the ventricular chambers.

For this reason, the actuator 4 according to the present disclosure is configured to exert a temporally asymmetrical stimulation profile. This means that the mechanical stimulation process exerted by the actuator 4 is such as to have different times for the ascending (e.g., contraction) and descending (e.g., relaxation) phases of the cycle. In other words, the time taken to go from an initial state to a final state is different than the time taken to return from the final state to the initial state.

Specifically, the mechanical stimulation is transferred from the actuator 4 to the stimulation point 5 such that the support element 2 expands locally at the stimulation point at a time t₁ and globally contracts at a time t₂, wherein t₁ is different from t₂, e.g., t₁>t₂.

It should be noted that the values of maximum pressure, volumetric deformation and frequency are in accordance with the profiles reported in the Wiggers diagram for a healthy heart.

The actuator 4 can comprise a force transmission system coupled to the stimulation point 5. Depending on the technology used to make the stimulation and control device 3, the actuator 4 can be of a different type.

In an example, at least one actuator 4 is a mechanical or electromechanical actuator, in particular a linear actuator or a servomotor. In this case, tendons, gears and pulleys can transmit the motion activated by motors and servomotors to the stimulation point 5 and thus to the patient's tissue, for example by acting directly on the tissue itself or indirectly by acting on the support element 2.

Additionally or alternatively, at least one actuator 4 is a pneumatic actuator, in particular comprising at least one air chamber connected to a pumping system and valves. In such a case, one or more air chambers are subjected to a continuous expansion and compression cycle through an air transmission system connected to pumps and valves.

Additionally or alternatively, at least one actuator 4 is a piezoelectric actuator, in particular comprising a piezoelectric material element coupled to a deformable mechanical element. In such a case, piezoelectric materials can be integrated with the interfaces of the support element 2 to alter the volume thereof when an electric current appropriately modulated in amplitude and frequency flows.

Additionally or alternatively, at least one actuator 4 is a memory polymer actuator, in particular comprising a thermoplastic polymer, thermosetting polymer or elastomeric polymer material. In this case, the shape memory polymers can change the extension state thereof, oscillating between one or more stable shapes due to external stimuli such as heat, locally ensuring a cyclic impression of mechanical forces.

In any case, the actuator 4 and/or the support element 2 can be made of materials having a hardness comprised between 10 and 30 Shore 00 to effectively emulate at the stimulation point 5 the volumetric deformation of the cardiac cycle during the systole and diastole phases.

Of course, different types of actuators 4 capable of imparting a mechanical stimulation at the stimulation point 5 can also be used.

FIGS. 2A and 2B show two types of wearable apparatus 1 for the treatment of cancer cells 10. In one case (FIG. 2A), the support element 2 is a textile or silicone band. The apparatus 1 can thus be worn on a patient's arm at a melanoma 10. In FIG. 2A, the double arrows indicate the action of the actuator 4 (not visible in the figure) on the band-shaped support element 2. The action of the actuator 4 can cause a constriction or a release of the band so that at the stimulation point 5 or at the cancer cells 10, a deformation of the support 2 and thus of the skin tissue occurs. The action of the actuator 4 is controlled by the control unit 7 so that the deformation varies over time as in the case of a cardiac contraction, according to for example the aforementioned parameters of pressure, frequency and/or volumetric variation.

In another case (FIG. 2B), the support element 2 is an undergarment, e.g., a bra. The apparatus 1 can thus be worn and the stimulation and control device 3 is located at the cancer cells 10, for example of the left breast.

Advantageously, the stimulation and control device 3 is removable from the support element 2 and can be conveniently placed on another region of the support element 2, for example at the right breast or another area of the left breast.

The stimulation point 5 is the active contact point between the apparatus 1 and the diseased tissue to be subjected to mechanical stimulation. In an example, at least one stimulation point 5 is integral with the support element 2.

For example, the stimulation point 5 can be a portion of the support element 2. In this case, the action of the actuator 4 is transferred to the support element 2 so that the stimulation point 5 is positioned on a region of the support element 2 in contact with the patient's tissue. In other words, the transmission of the mechanical stimulation from the actuator 4 to the stimulation point 5 occurs indirectly. For example, two or more points of the support element 2 can be pulled in opposite directions so as to cause a pressure at a region of the support element 2—i.e., the stimulation point 5—by means of, for example, a constriction of the support element 2 (e.g., constriction of the band around the patient's arm).

Additionally or alternatively, at least one stimulation point 5 can be integral with the stimulation and control device 3. For example, the stimulation point 5 can be a part of the actuator 4. In this case, the action of the actuator 4 is transferred directly to the stimulation point 5 which is in contact with the patient's tissue. In the latter case, the apparatus 1 can further comprise a thrust body 8 connected to the actuator 4, in which said thrust body 8 is rigid or deformable (shown in FIG. 1 as a dashed element). The thrust body is configured to impart a local force and pressure by expanding or extruding itself. The thrust body 8 can be for example a pin or a spherical body representing the transmission system of the mechanical stimulation. The thrust body can be integrated with or separate from the actuator 4. With reference to FIG. 3, three different modes of mechanical stimulation of cancer cells 10 are shown considering the configuration of the apparatus 1 of FIG. 2A, i.e., of a band applied around the arm of a patient.

In the example (i) of FIG. 3, the mechanical stimulation occurs by global contraction of the support element 2. For example, two strips of the band are pulled in the same direction. In this case, a stimulation occurs by cyclical contraction of the support 2 which compresses and releases the tissue to be treated in a cyclical, widespread and global manner. In particular, the constriction of the band generates a compression of the forearm, site of a melanoma, for example. Although the stimulation is widespread, the controlled closed-loop application occurs below the stimulation device 3 as an element capable of measuring the mechanical state of the tissue.

In the example (ii) of FIG. 3, the mechanical stimulation instead occurs by local expansion of the support element 2 at the stimulation point 5. For example, a thrust body 8 can be pressed by the action of the actuator 4 towards the stimulation point 5. In this case, a pneumatic device with a thrust body 8 can locally exert a pressure on the tissue to be treated by expansion of a deformable membrane. This is represented by the arrows exiting from the thrust body 8. The expansion of the thrust body 8 also spreads the stimulation to the tissues in contact with the support 2. Also in this case, the control circuit closes exclusively around the stimulation device 3 and in detail around the thrust body 8.

In example (iii) of FIG. 3, the mechanical stimulation occurs for a combination of the contraction according to example (i) and the expansion according to example (ii). In this case there is an integration of the two stimulation methods described above, i. e., diffused by means of the support 2 and locally by means of the thrust body 8.

In other words, the stimulation is exercised by means of the stimulation point 5 (for example a special thrust body or the band itself) which is activated by means of, for example, a motor controlled by the control unit 7 which integrates the information provided by the measurement sensor 6 with an internal programming thereof adapted to emulate the heartbeat. The resulting stimulation is then exerted on the patient's skin through constriction of the band, expansion of the stimulation point, or a combination thereof.

In an example, the actuator 4, the sensor 6 and the control unit 7 represent a closed-loop control system. In particular, the closed-loop control system is configured to carry out the measurement of a first force applied to the patient's tissue by means of the sensor 6, the generation of a control signal by the control unit 7 following at least said measurement, the activation of the actuator 4 by means of said control signal and the application of a second force, different from the first force, on the patient's tissue. The steps of this control process 100 are shown in FIG. 4.

In other words, the operation of the stimulation and control device 3 consists of a continuous cycle of force measurements, calculation of the force to be applied and application thereof according to the following model.

Initially the sensor 6 measures the force applied on the skin (S101). The control unit 7—on the basis of the information provided by the sensor 6 together with the force reference already known in its programming—generates a control signal (S102). The control signal activates an actuator 4 (S103).

The actuator 4 generates a deformation and/or a force which is transferred to the stimulation point 5 by means of a transmission system (S104). The closed-loop control system is a closed measurement-control-actuation loop around the patient's skin.

The design of the aforesaid devices as to materials, transmission and implementation meets the three paradigms of wearable robotics, namely i) safety, ii) convenience and iii) ease of use.

A person skilled in the art can perform several and further modifications and variants to the apparatus described above, in order to satisfy further and contingent needs, all said modifications and variants however included within the scope of protection of the present invention as defined by the appended claims.

1. A wearable apparatus for the treatment of cancer cells through a mechanical stimulation of a surface tissue of a patient, in particular the skin, the subcutis or the mammary gland, wherein the apparatus comprises:
a support element applicable to the tissue of said patient; and
a stimulation and control device connected to the support element, wherein said stimulation and control device comprises:
an actuator for transferring the mechanical stimulation a stimulation point;
a sensor for detecting a physical property among a pressure, a temperature, a hardness, a local deformation and/or an optical property at the tissue of the patient to be treated and for generating a corresponding sensor signal; and
a control unit connected to the actuator and to the sensor for regulating the activity of said actuator by means of a control signal as a function of said sensor signal,
wherein the mechanical stimulation is transferred from the actuator to the stimulation point and wherein the support element is configured to expand locally at the stimulation point, to contract globally or for a combination of said expansion and said contraction, according to a cyclical trend.

2. The apparatus according to claim 1, wherein the mechanical stimulation transferred from the actuator to the stimulation point causes on the stimulation point
a. a maximum pressure greater than 120 mmHg; and/or
b. a maximum local volumetric deformation of at least 130 ml; and/or
c. a frequency greater than or equal to 1 Hz.

3. The apparatus according to claim 1, wherein a stimulation point is integral with the stimulation and control device.

4. The apparatus according to claim 3, wherein the apparatus further comprises a thrust body connected to the actuator, wherein said thrust body is rigid or deformable.

5. The apparatus according to claim 1, wherein the stimulation point is integral with the support element.

6. The apparatus according to claim 1, wherein the actuator is a mechanical or electromechanical actuator, in particular a linear actuator or a servomotor.

7. The apparatus according to claim 1, wherein the actuator is a pneumatic actuator, comprising an air chamber connected to a pumping system and valves.

8. The apparatus according to claim 1, wherein at least one actuator is a piezoelectric actuator, comprising an element in piezoelectric material coupled to a deformable mechanical element.

9. The apparatus according to claim 1, wherein the actuator is a memory polymer actuator, comprising a thermoplastic polymer, thermosetting polymer or elastomeric polymer material.

10. The apparatus according to claim 1, wherein the actuator the sensor and the control unit represent a closed-loop control system, wherein the closed-loop control system is configured to carry out the measurement of a first force applied on the patient's tissue by means of the sensor the generation of a control signal by the control unit following at least said measurement, the activation of the actuator by means of said control signal and the application of a second force, different from the first force, on the patient's tissue.

11. The apparatus according to claim 1, further comprising a battery connected to the control unit wherein the battery is a rechargeable battery.

12. The apparatus according to claim 1, wherein the support element is a band or an item of clothing.
